(19) United States
(12) Patent Application Publication
(10) Pub. No.: US 2024/0120536 A1
(43) Pub. Date: Apr. 11, 2024

(54) CONDUCTIVE SULFAMIDE POLYMERS, THEIR USE IN BATTERIES, AND METHOD OF MANUFACTURE THEREOF

(71) Applicant: HYDRO-QUÉBEC, Montréal, Québec (CA)

(72) Inventors: Jean-Christophe DAIGLE, Saint-Bruno-de-Montarville, Québec (CA); Annie-Pier LAROUCHE, Sainte-Julie, Québec (CA); Sylviane ROCHON, Saint-Adèlphe, Québec (CA); Sergey KRACHKOVSKIY, Boucherville, Québec (CA); Francis BARRAY, Saint-Simon-de-Bagot, Québec (CA); Julie HAMEL-PÂQUET, Boucherville, Québec (CA)

(73) Assignee: HYDRO-QUÉBEC, Montréal, Québec (CA)

(21) Appl. No.: 18/256,932

(22) PCT Filed: Dec. 14, 2021
(86) PCT No.: PCT/CA2021/051796

§ 371 Date: Jun. 12, 2023

Related U.S. Application Data
(60) Provisional application No. 63/126,369, filed on Dec. 16, 2020.

(51) Int. Cl. H01M 10/0565; C08G 75/30

(52) U.S. Cl. CPC H01M 10/0565; C08G 75/30; H01M 2300/0082

(57) ABSTRACT

A polymer of formula (I), wherein the nitrogen atoms are coordinated with a lithium atom in 0% to 100% of repeat units in the polymer, and each R1 in each individual repeat unit independently represents a bivalent group, wherein the bivalent groups are, independently from one another, alkylene, arylene, or —CH₂—CH₂—(O—CH₂—CH₂)ₘ—, wherein m is an integer of 1 or more, and wherein the alkylene, the arylene, and the —CH₂—CH₂—(O—CH₂—CH₂)ₘ— are optionally substituted with one or more halogen atoms. The polymers of the invention can be used as battery electrolytes.

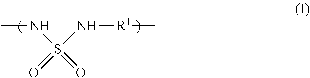

### CROSS REFERENCE TO RELATED APPLICATIONS

This application is a U.S. National Stage of International Application No. PCT/CA2021/051796, filed on Dec. 14, 2021, which claims benefit, under 35 U.S.C. § 119(e), of U.S. Provisional Application No. 63/126,369, filed on Dec. 16, 2020. The entire contents of each of the International Application No. PCT/CA2021/051796 and U.S. Provisional Application No. 63/126,369 are entirely incorporated herein by reference.

### FIELD OF THE INVENTION

The present invention relates to a polymer comprising lithiated and/or non-lithiated modified sulfamide repeat units and its use as battery electrolyte.

### BACKGROUND OF THE INVENTION

Poly(ethylene oxide) (PEO) based materials are widely considered as promising candidates of polymer hosts in solid-state electrolytes for high energy density secondary lithium batteries. They have several specific advantages such as high safety, easy fabrication, low cost, high energy density, good electrochemical stability, and excellent compatibility with lithium salts. However, the typical linear PEO does not meet the production requirement because of its insufficient ionic conductivity due to the high crystallinity of the ethylene oxide (EO) chains, which can restrain the ionic transition due to the stiff structure especially at low temperature. Scientists have explored different approaches to reduce the crystallinity and hence to improve the ionic conductivity of PEO-based electrolytes, including blending, modifying and making PEO derivatives.

### SUMMARY OF THE INVENTION

In accordance with the present invention, there is provided:
1. A polymer of formula (I):

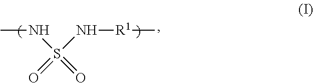

wherein:
the nitrogen atoms are coordinated with a lithium atom in 0% to 100% of repeat units in the polymer, and
each R¹ in each individual repeat unit independently represents a bivalent group, wherein the bivalent groups are, independently from one another, alkylene, arylene, or —CH₂—CH₂—(O—CH₂—CH₂)ₘ—, wherein:
   m is an integer of 1 or more, and
   the alkylene, the arylene, and the —CH₂—CH₂—(O—CH₂—CH₂)ₘ— are optionally substituted with one or more halogen atoms.
2. The polymer of item 1, wherein the nitrogen atoms are coordinated with a lithium atom in >0%, preferably at least about 50%, more preferably at least about 60%, yet more preferably at least about 70%, even more preferably at least about 80%, still more preferably at least about 90%, and most preferably in about 100% of the repeat units in the polymer.
3. The polymer of item 1 or 2, wherein the alkylene is a linear alkylene.
4. The polymer of any one of items 1 to 3, wherein the alkylene is a C₃-C₁₂alkylene, preferably a C₃-C₆alkylene, and most preferably butylene (C₄).
5. The polymer of any one of items 1 to 4, wherein each of the rings of the arylene comprises 5 or 6 ring atoms.
6. The polymer of any one of items 1 to 5, wherein the arylene is a monocyclic arylene, preferably phenylene, more preferably paraphenylene.
7. The polymer of any one of items 1 to 6, wherein the alkylene is substituted with one or more halogen atoms.
8. The polymer of any one of items 1 to 7, wherein the halogen atoms are fluorine atoms.
9. The polymer of any one of items 1 to 8, wherein the alkylene is 2,2,3,3-tetrafluoro-1,4-butylene.
10. The polymer of any one of items 1 to 6, wherein the alkylene is unsubstituted.
11. The polymer of any one of items 1 to 10, wherein the arylene is unsubstituted.
12. The polymer of any one of items 1 to 11, wherein m is at least 2, preferably at least 3.
13. The polymer of any one of items 1 to 12, wherein m is at most 15, preferably at most 10, and more preferably at most 5.
14. The polymer of any one of items 1 to 13, wherein m is 1, 2, or 3; preferably 2 or 3, and more preferably 3.
15. The polymer of any one of items 1 to 14, wherein each R¹ in each individual repeat unit represents a same bivalent group.
16. The polymer of item 15, wherein R¹ represents an alkylene or —CH₂—CH₂—(O—CH₂—CH₂)ₘ—; more preferably —CH₂—CH₂—(O—CH₂—CH₂)ₘ—, wherein the alkylene and m are as defined in any one of items 1 to 14.
17. The polymer of any one of items 1 to 13, wherein each R¹ in each individual repeat unit independently represents a total of more than one bivalent group, preferably a total of two bivalent groups.
18. The polymer of item 17, wherein the more than one bivalent groups are independently alkylene and/or —CH₂—CH₂—(O—CH₂—CH₂)ₘ—.
19. The polymer of item 17 or 18, wherein each R¹ in each individual repeat unit independently represents a total of two bivalent groups, wherein:
   one of the two bivalent group is an alkylene and the other of the two bivalent groups is —CH₂—CH₂—(O—CH₂—CH₂)ₘ—, or
   one of the two bivalent group is —CH₂—CH₂—(O—CH₂—CH₂)ₘ—, wherein m has a first value, and the other of the two bivalent groups is —CH₂—CH₂—(O—CH₂—CH₂)ₘ—, wherein m has a second value different from the first value,
wherein the alkylene and m are as defined in any one of items 1 to 13.
20. The polymer of item 19, wherein the first value and the second value for m are selected from 1, 2, and 3; preferably from 2 and 3.
21. The polymer of any one of items 1 to 20, wherein:
   each R¹ in each individual repeat unit represents —CH₂—CH₂—(O—CH₂—CH₂)ₘ—, wherein m is 2 or 3, preferably 3;
   each R¹ in each individual unit independently represents a total of two bivalent groups, wherein one of the two bivalent groups is —CH₂—CH₂—(O—CH₂—CH₂)ₘ—, wherein m is 2, and the other of the two bivalent groups is —CH₂—CH₂—(O—CH₂—CH₂)ₘ—, wherein m is 3;
   each R¹ in each individual repeat unit independently represents a total of two bivalent groups, wherein one of the two bivalent groups is 2,2,3,3-tetrafluoro-1,4-butylene and the other of the two bivalent groups is —CH₂—CH₂—(O—CH₂—CH₂)ₘ—, wherein m is 2 or 3, preferably 3.
22. The polymer of any one of items 1 to 21, wherein the repeat units are randomly arranged in the polymer.
23. The polymer of any one of items 1 to 22, having a molar mass between 5,000-5,000,000 gmol⁻¹.
24. The polymer of any one of items 1 to 23, having no crystallinity.
25. The polymer of any one of items 1 to 24, having a glass transition temperature (Tg) around −30° C.
26. A method of manufacturing the polymer of any one of items 1 to 25, the method comprising an oxidative catalytic reaction of sulfamide with one or more diols in the presence of a copper salt and optionally a lithium base.
27. The method of item 26, wherein the one or more diol is used in excess
28. The method of item 27, wherein the sulfamide and the one or more diol are used in a 1:4 sulfamide:total diol molar ratio.
29. The method of any one of items 26 to 28, wherein a single diol is used.
30. The method of any one of items 26 to 28, wherein more than one diols are used.
31. The method of any one of items 26 to 30, wherein the copper salt is copper triflate or copper acetate.
32. The method of any one of items 26 to 31, wherein the lithium base is present.
33. The method of any one of items 26 to 32, wherein the lithium base is lithium carbonate.
34. The method of any one of items 26 to 33, wherein the copper salt is copper acetate.
35. The method of any one of items 26 to 34, further comprising the step of passing the polymers in an ion-exchange resin on the polymer post-polymerization to increase a degree of lithiation of the polymer.
36. The method of any one of items 26 to 31, wherein the lithium base is absent.
37. The method of any one of items 26 to 31 and 26, wherein the copper salt is copper triflate.
38. The method of any one of items 26 to 37, wherein the sulfamide, the copper salt, and the lithium base if it is used, are first mixed together and then diol is added.
39. Use of the polymers of any one of items 1 to 25 as an electrolyte for a battery.
40. An electrolyte for a battery comprising the polymer of any one of items 1 to 25.
41. A battery comprising an anode, a cathode, and an electrolyte between the anode and the cathode, wherein the electrolyte comprises the polymer of any one of items 1 to 25.

### BRIEF DESCRIPTION OF THE DRAWINGS

In the appended drawings:

FIG. 1 shows the FTIR spectrum of the polymer of Example 13.

FIG. 2 shows the H1 solid NRM spectrum of the polymers of Example 2a, Example 13 (i.e. Example 2a after treatment with ion-exchange resin) and Example 2a with 20 wt % LITFSI.

FIG. 3 shows the thermogravimetric analysis (TGA) results for the polymer of Example 1b.

FIG. 4 shows the TGA results for the polymer of Example 3a.

FIG. 5 is an exploded view of the button battery assembled in Example 5.

FIG. 6 shows an equivalent circuit used when calculating the conductivity.

FIG. 7 show another equivalent circuit used when calculating the conductivity.

FIG. 8 shows the conductivity results for the polymer from Example 2a (made from triethylene glycol) with either 0, 20, 30, 40, or 50 w/w % of LiTFSI.

FIG. 9 shows the conductivity results for the polymer from Example 1a (made from tetraethylene glycol) with either 0, 10, 20, or 30 w/w % of LiTFSI.

FIG. 10 compares the conductivities of the polymer from Example 2a (made from triethylene glycol) and the polymer from Example 1a (made from tetraethylene glycol) at different salt levels.

FIG. 11 shows the conductivity of the polymer of Example 1b mixed with 15 wt % of polymer HQ674.

FIG. 12 shows the conductivity of the polymers of Examples 1b and 7, with or without salt, without or without polymer HQ674 and compares the conductivity of polymer HQ674.

FIG. 13 shows the conductivity of the polymer of Example 6 alone, mixed with PVDF, or mixed with both PVDF and LATP.

### DETAILED DESCRIPTION OF THE INVENTION

Turning now to the invention in more details, there is provided a polymer of formula (I):

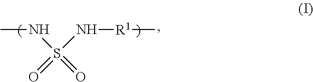

wherein:
the nitrogen atoms are coordinated with a lithium atom in 0% to 100% of repeat units in the polymer, and
each R¹ in each individual repeat unit independently represents a bivalent group, wherein the bivalent groups are, independently from one another, alkylene, arylene, or —CH₂—CH₂—(O—CH₂—CH₂)ₘ—, wherein:
   m is an integer of 1 or more, and
   the alkylene, the arylene, and the —CH₂—CH₂—(O—CH₂—CH₂)ₘ— are optionally substituted with one or more halogen atoms.

As shown in the Examples below, the polymers of the invention have a good conductivity even at low temperature (e.g. 4.10×10⁻⁵ Scm⁻¹ at 50° C.). Also, in some cases, their conductivity is maximal in the absence of a salt. While the overall conductivity of the polymers of the invention is slightly lower than that of PEO, its transport number is much higher (from 0.2 of PEO compared to e.g. ˜0.9 for the polymer of the invention). This is extremely significant because ionic conductivity reported is a value related with cationic and anionic contribution; therefore, transport number (t⁺+t⁻=1) is associated with the movement of cation and anions. Because t+ of Li in PEO is low, movement of TFSI− is major, and contributed more to the conductivity. In our polymer, Li⁺ ions move faster compared to counter-anions (polymer backbone). PEO is only a vector of movement for LiTFSI. Further, we can see that the activation energy of the polymers of the invention is very different from that typically observed for polymers (1.7 eV PEO+Li crystal). It is much better and is, in fact, closer to that reported for ceramics (0.30 eV).

As noted above, the nitrogen atoms are coordinated with a lithium atom in 0% to 100% of the repeat units in the polymer. This means that 0% to 100% of the repeat units are lithiated, while the remaining repeat units are non-lithiated. Indeed, as shown in the Examples below, in particular in the NMR and FTIR spectra, the nitrogen atoms in the polymer of the invention can be coordinated with a lithium atom, thus forming a complex, at level of up to 1 lithium atom per repeat unit.

In embodiments, the nitrogen atoms are coordinated with a lithium atom in 0% of the repeat units in the polymer. In such cases, the polymer is completely non-lithiated.

In embodiments, the nitrogen atoms are coordinated with a lithium atom in 100% of the repeat units in the polymer. In such cases, the polymer is completely lithiated.

In preferred embodiments, the nitrogen atoms are coordinated with a lithium atom in >0% of the repeat units in the polymer, which means that the polymer comprises at least some lithiated repeat unit. In preferred embodiments, the nitrogen atoms are coordinated with a lithium atom in at least about 50%, preferably at least about 60%, more preferably at least about 70%, yet more preferably at least about 80%, and most preferably at least about 90% of the repeat units in the polymer. In most preferred embodiments, the nitrogen atoms are coordinated with a lithium atom in about 100% of the repeat units in the polymer. In such embodiments, all or almost all the repeat units in the are lithiated repeat units.

In embodiments, the alkylene is a linear alkylene.

In embodiments, the alkylene is a C₃-C₁₂alkylene, preferably a C₃-C₆alkylene, and most preferably butylene (C₄).

In embodiments, each of the rings of the arylene comprises 5 or 6 ring atoms.

In embodiments, the arylene is a monocyclic arylene. In preferred embodiments, the arylene is a phenylene, more preferably paraphenylene.

As noted above, the alkylene, the arylene, and the —CH₂—CH₂—(O—CH₂—CH₂)ₘ— groups are optionally substituted with one or more halogen atoms. Preferred halogen atoms include fluorine. In such embodiments, preferred R¹ groups include alkylene groups substituted with one or more halogen atoms. A preferred R¹ group is 2,2,3,3-tetrafluoro-1,4-butylene.

In preferred embodiments, the alkylene is substituted, preferably as described above. In alternative embodiments, the alkylene is unsubstituted.

In preferred embodiments, the arylene is unsubstituted.

In preferred embodiments, m is at least 2, preferably at least 3.

In preferred embodiments, m is at most 15, preferably at most 10, and more preferably at most 5.

In preferred embodiments, m is 1, 2, or 3; preferably 2 or 3, and more preferably 3.

As noted above, each R¹ in each individual repeat unit independently represents a bivalent group. This means that different repeat units in the polymer can comprise different bivalent groups. More specifically, when more than one bivalent group are present, a part of the repeat units in the polymer will comprise a first bivalent group, another part of the repeat units will comprise a bivalent group, if there is a third bivalent group, then yet another part of the repeat units will comprise the third bivalent group, and so on for each bivalent group. For example, a polymer may comprise repeat units (lithiated and/or non-lithiated) wherein R¹ is an alkylene as well as other repeat units (lithiated and/or non-lithiated), wherein R¹ is —CH₂—CH₂—(O—CH₂—CH₂)ₘ—. As another example, the polymer may comprise repeat units wherein R¹ is —CH₂—CH₂—(O—CH₂—CH₂)ₘ—, wherein m is 3, and other repeat units wherein R¹ is also —CH₂—CH₂—(O—CH₂—CH₂)ₘ—, but wherein m is 4.

In preferred embodiments, each R¹ in each individual repeat unit represents a same bivalent group; in other words, each and every repeat unit in the polymer comprises the same bivalent group. In preferred such embodiments, R¹ preferably represents an alkylene or —CH₂—CH₂—(O—CH₂—CH₂)ₘ—; more preferably —CH₂—CH₂—(O—CH₂—CH₂)ₘ—, wherein the alkylene and m are as defined above, including the preferred embodiments thereof.

In alternative preferred embodiments, each R¹ in each individual repeat unit independently represents a total of more than one bivalent group. In other words, different repeat units in the polymer contain different bivalent groups. This means that R¹ represents a first bivalent group in some of the lithiated repeat units and non-lithiated repeat units, while R¹ independently represents a second, third, fourth (and so on) bivalent group (preferably a second or third bivalent group, and more preferably a second bivalent group) in other lithiated repeat units and non-lithiated repeat units, the second, third, or fourth (and so on) bivalent groups being different from one another and different from the first bivalent group. In preferred such embodiments, each R¹ in each individual repeat unit independently represents a total of two bivalent groups. In preferred such embodiments, these more than one (preferably two) bivalent groups are independently alkylene and/or —CH₂—CH₂—(O—CH₂—CH₂)ₘ—. In more preferred embodiments, each R¹ in each individual non-lithiated repeat unit independently represents a total of two bivalent groups, wherein:
one of the two bivalent group is an alkylene and the other of the two bivalent groups is —CH₂—CH₂—(O—CH₂—CH₂)ₘ—, or
one of the two bivalent group is —CH₂—CH₂—(O—CH₂—CH₂)ₘ—, wherein m has a first value, and the other of the two bivalent groups is —CH₂—CH₂—(O—CH₂—CH₂)ₘ—, wherein m has a second value different from the first value.
   In all such cases, the alkylene and m are as defined above, including the preferred embodiments thereof. In preferred such embodiments, the first and second values for m are selected from 1, 2, and 3; preferably from 2 and 3.

In most preferred embodiments:
each R¹ in each individual repeat unit represents —CH₂—CH₂—(O—CH₂—CH₂)ₘ—, wherein m is 2 or 3, preferably 3;
each R¹ in each individual repeat unit independently represents a total of two bivalent groups, wherein one of the two bivalent groups is —CH₂—CH₂—(O—CH₂—CH₂)ₘ—, wherein m is 2, and the other of the two bivalent groups is —CH₂—CH₂—(O—CH₂—CH₂)ₘ—, wherein m is 3;
each R¹ in each individual lithiated repeat unit independently represents a total of two bivalent groups, wherein one of the two bivalent groups is 2,2,3,3-tetrafluoro-1,4-butylene and the other of the two bivalent groups is —CH₂—CH₂—(O—CH₂—CH₂)ₘ—, wherein m is 2 or 3, preferably 3.

In preferred embodiments, the repeat units are randomly arranged in the polymer. This means that the lithiated and non-lithiated repeat units are not segregated from one another (as they would be in a block copolymer), nor placed in any particular order in the polymer (e.g. they do not need to be alternating). This also means that the repeat units containing different bivalent groups are not segregated from one another, nor placed in any particular order in the polymer.

The polymers of invention can be manufactured as described in the next section. Typically, such polymers have a molar mass between 50,000-5,000,000 gmol⁻¹.

Also, they typically have no crystallinity with a glass transition temperature (Tg) around −30° C.

### Method of Manufacture

In a related aspect of the invention, there is provided a method of manufacturing the above polymers. The method comprises the oxidative catalytic reaction of sulfamide with a diol in the presence of a copper salt and optionally a lithium base.

The polymer of the invention can indeed, be produced by an oxidative catalytic reaction. In this reaction, sulfamide (NH₂—SO₂—NH₂) and a diol corresponding to the desired R¹ are reacted together. Exemplary generic reaction schemes are provided below:

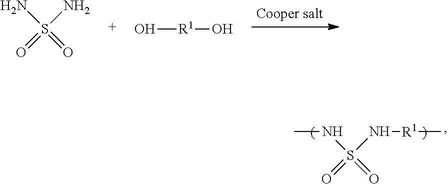

free of lithiated repeat units,

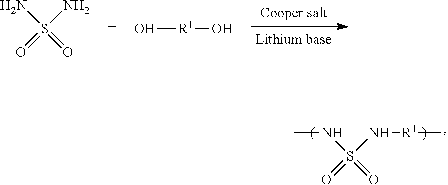

comprising lithiated repeat units,
wherein R¹ is as defined in the previous section.

As can be seen above, the diol looses both its hydroxyl groups in the reaction, yielding the R¹ group in the polymer of the invention. Hence, the diol can be selected according to the R¹ group desired in the polymer.

To prepare polymers of the invention in which each R1 in each individual repeat unit independently represents a total of more than one bivalent groups, one only need to use two different diols in the above reaction. This will thus produce a polymer containing repeat units with R¹ bivalent groups originating from one diol as well as repeat units with R¹ bivalent groups originating from another diol (and so on if more than two diols are used).

In this reaction, the diol also acts as a reaction solvent.

The reaction time can be from 3 hours to 12 hours depending on the diol used.

The diol is typically used in excess as it also plays the role of reaction solvent. In preferred embodiments, the sulfamide and the diol(s) are used in a 1:4 sulfamide:total diol molar ratio.

The catalytic system for this reaction comprises a copper salt and optionally a lithium base. To produce a polymer free of lithiated repeat units, the lithium base is omitted. However, to produce a polymer comprising lithiated repeat units, a lithium base is used. This allows producing a polymer comprising up to 60% of lithiated repeat units. To produce polymers with higher lithiation levels (up to 100% of repeat units), the method further comprises the step of passing the polymers in an ion-exchange resin on the polymer post-polymerization.

Non-limiting examples of copper salts include copper triflate and copper acetate. Preferably, the copper salt is copper acetate as it allows the production of polymers with lithiated repeat units (contrary to copper triflate).

Preferably, the lithium base is lithium carbonate.

Non-limiting examples of ion-exchange resins include silica resins, such as the Dowex™ 50×8 H⁺ resin, treated with lithium ions.

In embodiments, lithium carbonate and copper acetate are used to produce polymers comprising up to about 60% of lithiated repeat units. In alternative embodiments, copper triflate is used without base to produce polymers free of lithiated repeat units.

In embodiments, the solids (the sulfamide, the copper salt, and the lithium base if it is used) are first mixed together and then diol is added.

This method is shown in the Examples below to produce linear polymers with a molar mass between 5,000-5,000,000 gmol⁻¹. Also, these polymers typically have no crystallinity with a glass transition temperature (Tg) around −30° C.

### Uses and Applications

The polymers of the invention can be used as battery electrolytes.

In embodiments, when used as battery electrolyte, the polymer of the invention is in a battery comprising an anode, a cathode, and an electrolyte between the anode and the cathode, wherein the electrolyte comprises the polymer of the invention.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

Similarly, herein a general chemical structure, such as Formula I, with various substituents (R₁, R₂, etc.) and various radicals (alkyl, halogen atom, etc.) enumerated for these substituents is intended to serve as a shorthand method of referring individually to each and every molecule obtained by the combination of any of the radicals for any of the substituents. Each individual molecule is incorporated into the specification as if it were individually recited herein. Further, all subsets of molecules within the general chemical structures are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Herein, the terms “alkyl” and “alkylene” as well as their derivatives (such as alkoxy, alkyleneoxy, etc.) have their ordinary meaning in the art. For more certainty, herein:

| | |
|---|---|
| Term | Definition |

Saturated aliphatic hydrocarbons

| | |
|---|---|
| alkane | aliphatic hydrocarbon of general |
| | formula CₙH₂ₙ₊₂ |
| alkyl | monovalent alkane radical of general |
| | formula —CₙH₂ₙ₊₁ |
| alkylene | bivalent alkane radical of general |
| (also called alkanediyl) | formula —CₙH₂ₙ— |

It is to be noted that, unless otherwise specified, the hydrocarbon chains of the above groups can be linear or branched. Further, unless otherwise specified, these groups can contain between 1 and 18 carbon atoms, more specifically between 1 and 12 carbon atoms, between 1 and 6 carbon atoms, between 1 and 3 carbon atoms, or contain 1 or 2, preferably 1, or preferably 2 carbon atoms.

Herein, the terms “aryl” and their derivatives have their ordinary meaning in the art. For more certainty, herein:

| Term | Definition |
|---|---|
| arene | aromatic hydrocarbon presenting alternating double and single |
| | bonds between carbon atoms arranged in one or more rings. |
| aryl | monovalent arene radical |
| arylene | bivalent arene radical |

It is to be noted that, unless otherwise specified, each ring of the above groups can comprise between 4 and 8, preferably 5 or 6 ring atoms.

Also, each of the above compound may comprise more than one ring. In other words, they can be polycyclic. Polycyclic arenes are composed of multiple aromatic rings (organic rings in which the electrons are delocalized). Polycyclic arenes comprise fused aromatics. These are compounds that comprise two or more aromatic rings fused together by sharing two neighboring carbon atoms. The simplest such compounds are naphthalene, having two aromatic rings, and the three-ring compounds anthracene and phenanthrene. Polycyclic arenes also comprise compounds in which aromatic rings are attached to each other via a covalent bond or a carbon atom (bearing 0, 1, or 2 hydrogen atoms as needed depending on the number of aromatic rings to which it is attached).

Herein, a “ring atom”, such as a ring carbon atom or a ring heteroatom, refers to an atom that forms (with other ring atoms) a ring of a cyclic compound, such as a cycloalkyl, an aryl, etc.

Herein, an “heteroatom” is an atom other than a carbon atom or a hydrogen atom. Preferably, the heteroatom is oxygen or nitrogen.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Polymer Synthesis

Polymers of the invention were synthesized using the manufacture method described above.

Briefly, the sulfamide, copper acetate, diol, and lithium carbonate were added to a flask equipped a stirrer and a condenser. The flask was placed in a sand bath heated to 170° C. so that the temperature was around 165° C. in the flask. The reaction was allowed to proceed for 5-12 hours depending on the diol. Then, the heating was stopped and 10-20 mL of methanol were slowly added to stop the reaction. The reaction mixture was then allowed to cool and then passed through Celite™ prewashed with methanol The reaction mixture was evaporated until its volume was half its original value and then precipitated in 10× volume of ethyl acetate cooled to 4° C. for purification. The polymer was allowed to stick to the walls of the vessel for a few minutes. Then, the vessel was put in the freezer for 15 minutes. Finally, the mixture was decanted and dried in a vacuum oven for a few hours at 60° C. If present, insoluble particles can be detected visually. The polymer was dissolved in a minimum of methanol and poured in five volumes of dichloromethane. The precipitate was removed by centrifugation and the solution with the soluble polymer was evaporated to dry. The polymer was dried in a vacuum oven few at 60° C.

The other reaction conditions were the following:

| | | | | | Duration |
|---|---|---|---|---|---|
| Polymer | Diol | Sulfamide | Cooper salt | Base | (Yield) |
| Example 1a | Tetraethylene | 1 eq | Copper acetate | Li₂CO₃ | 3 h |
| | glycol | | 60 mg per 1.25 g of sulfamide | 1.2 eq | (41%) |
| | 4 eq | | | | |
| Example 1b | Tetraethylene | 1 eq | Copper acetate | Li₂CO₃ | 5 h |
| | glycol | | 60 mg per 1.25 g of sulfamide | 1.2 eq | (74%) |
| | 4 eq | | | | |
| Example 1c | Tetraethylene | 1 eq | Copper acetate | Li₂CO₃ | 12 h |
| | glycol | | 60 mg per 1.25 g of sulfamide | 1.2 eq | (55%) |
| | 4 eq | | | | |
| Example 1d | Tetraethylene | 1 eq | Copper acetate | Li₂CO₃ | 5 h |
| | glycol (72.0 | | 480 mg per 10.0 g of | 1.2 eq | (65%) |
| | mL) | | sulfamide | | |
| Example 2a | Triethylene | 1 eq | Copper acetate | Li₂CO₃ | 5 h |
| | glycol | | 60 mg per 1.25 g of sulfamide | 1.2 eq | (58%) |
| | 4 eq | | | | |
| Example 2b | Triethylene | 1 eq | Copper acetate | Li₂CO₃ | 12 h |
| | glycol | | 60 mg per 1.25 g of sulfamide | 1.2 eq | (27%) |
| | 4 eq | | | | |
| Example 3a | Diethylene | 1 eq | Copper acetate | Li₂CO₃ | 3 h |
| | glycol | | 60 mg per 1.25 g of sulfamide | 1.2 eq | (44%) |
| | 4 eq | | | | |
| Example 3b | Diethylene | 1 eq | Copper acetate | Li₂CO₃ | 5 h |
| | glycol | | 60 mg per 1.25 g of sulfamide | 1.2 eq | (39%) |
| | 4 eq | | | | |
| Example 3c | Diethylene | 1 eq | Copper acetate | Li₂CO₃ | 6.5 h |
| | glycol | | 60 mg per 1.25 g of sulfamide | 1.2 eq | (35%) |
| | 4 eq | | | | |
| Example 3d | Diethylene | 1 eq | Copper acetate | Li₂CO₃ | 12 h |
| | glycol | | 60 mg per 1.25 g of sulfamide | 1.2 eq | (45%) |
| | 4 eq | | | | |
| Example 3e | Diethylene | 1 eq | Copper triflate 100 mg per | None | 1 h |
| | glycol | | 2.0 g sulfamide | | (62%) |
| | 1 eq | | | | |
| Example 3f | Diethylene | 1 eq | Copper triflate 150 mg per | None | 22 h |
| | glycol | | 2.0 g sulfamide | | (25%) |
| | 1 eq | | | | |
| Example 3g | Diethylene | 1 eq | Copper triflate 150 mg per | None | 12 h |
| | glycol | | 2.0 g sulfamide | | (39%) |
| | 4 eq | | | | |
| Example 4a | Ethylene glycol | 1 eq | Copper acetate | Li₂CO₃ | 5 h |
| (comparative) | 4 eq | | 60 mg per 1.25 g of sulfamide | 1.2 eq | No |
| | | | | | polymer |
| | | | | | obtained |
| Example 4b | Ethylene glycol | 1 eq | Copper acetate | Li₂CO₃ | 12 h |
| (comparative) | 4 eq | | 60 mg per 1.25 g of sulfamide | 1.2 eq | No |
| | | | | | polymer |
| | | | | | obtained |
| Example 5a | 1,3-propanediol | 1 eq | Copper acetate | Li₂CO₃ | 5 h |
| | 4 eq | | 60 mg per 1.25 g of sulfamide | 1.2 eq | (52%) |
| Example 5b | 1,3-propanediol | 1 eq | Copper acetate | Li₂CO₃ | 12 h |
| | 4 eq | | 60 mg per 1.25 g of sulfamide | 1.2 eq | (44%) |
| Example 6 | PEG 400 Mn | 1 eq | Copper acetate | Li₂CO₃ | 4 h |
| | 4 eq | | 60 mg per 1.25 g of sulfamide | 1.2 eq | (60%) |
| Example 7 | 2,2,3,3- | 1 eq | Copper acetate | Li₂CO₃ | 12 h |
| | Tetrafluoro-1,4- | | 240 mg per 5.00 g of | 1.2 eq | (70%) |
| | butanediol | | sulfamide | | |
| | 2.0 g + | | | | |
| | tetraethylene | | | | |
| | glycol | | | | |
| | 34.0 mL | | | | |
| Example 8 | Triethylene | 1 eq | Copper acetate | Li₂CO₃ | 5 h |
| | glycol | | 240 mg per 5.00 g of | 1.2 eq | (66%) |
| | 17.0 mL + | | sulfamide | | |
| | tetraethylene | | | | |
| | glycol | | | | |
| | 18.0 mL | | | | |
| Example 9 | Benzene-1,4- | 1 eq | Copper acetate | Li₂CO₃ | No |
| (comparative) | diol | | 60 mg per 1.25 g of sulfamide | 1.2 eq | polymer |
| | 4 eq | | | | obtained |
| Example 10 | cis-2-butene- | 1 eq | Copper acetate | Li₂CO₃ | 12 h |
| (comparative) | 1,4-diol | | 60 mg per 1.25 g of sulfamide | 1.2 eq | No |
| | 4 eq | | | | polymer |
| | | | | | obtained |
| Example 11 | 1,6- hexane | 1 eq | Copper acetate | Li₂CO₃ | 5 h |
| | diol | | 60 mg per 1.25 g of sulfamide | 1.2 eq | (50%) |
| | 4 eq | | | | |

The inventors observed that the yields of the reaction were slightly higher when the solids (sulfamide, copper salt, and lithium base if it is used) were first mixed together before the diol was added.

### Degree of Lithiation

To increase the level of lithiation, some of the above polymers were passed through an ion-exchange resin. Namely, the polymer was dissolved in a minimum of methanol and stirred for 12 hours with 30% by mass of the Li⁺ resin described below. The solution was filtered and evaporated to dryness. Dry under vacuum at 60 oC for 4 hours.

Dowex™ 50×8 H⁺ resin: A glass column (approximately 30 g) was filled with resin and wetted with a 2M aqueous solution of LiOH. Once the liquid exiting the column tap was basic, the eluent was changed to ultrapure water until a neutral pH was reached. Then, the resin was washed with 300 ml of methanol. The resin was dried at 60° C. for 12 hours. An alternative method was to put the resin in a beaker with 300 mL of 2M LiOH in water. Stir it for 12 hours then filter and wash is with ultrapure water until a neutral pH was observed and then proceed with methanol and dry.

The degree of lithiation of the starting polymers and the polymers after the treatment with the ion-exchange resin was calculated from their Li⁷, solid NMR spectra based on LiCl calibration.

The polymers and their degrees of lithiation before and after treatment were as follows:

| | | | % mol Li | |
|---|---|---|---|---|
| | | | Before | After |
| | | | ion-exchange | ion-exchange |
| Polymer | Starting polymer | Diol | resin | resin |
| Example | Polymer from | Tetraethylene glycol | Not available | 86% |
| 12 | Example 1d | | | |
| Example | Polymer from | Triethylene glycol | 63% | 93% |
| 13 | Example 2a | | | |
| Example | Polymer from | Diethylene glycol | Not available | 60% |
| 14 | Example 3d | | | |
| Example | Polymer from | 2,2,3,3-Tetrafluoro-1,4-butanediol + | Not available | 38% |
| 15 | Example 7 | tetraethylene glycol | | |
| Example | Polymer from | Tetraethylene glycol + | Not available | 79% |
| 16 | Example 8 | triethylene glycol | | |

### NMR Characterization & Structure Elucidation

H¹ liquid NMR spectra of the produced polymers were recorded using Bruker Ultrashield 300.

The NMR peaks for these polymers were as follow.

| Polymer | List of NMR peaks |
|---|---|
| Polymers of Example 1 | 1.3 ppm; 2.1 ppm; 3.3 ppm; 3.4 ppm; 3.5 ppm; 3.6-3.9 ppm; 4.0 |
| (diol = tetraethylene glycol) | ppm; 4.2 ppm (D₂O) |
| From Example 1a | 0.97 ppm; 1.46 ppm; 1.81 ppm; 2.33 ppm; 2.58 ppm; 2.71 ppm; |
| (diol = tetraethylene glycol) | 2.99 ppm; 3.2-3.4 ppm; 3.64 ppm; 4.48 ppm; 5.56 ppm (DMSO d-6) |
| From Example 12 (Example 1a lithiated) | 0.87 ppm; 2.33 ppm; 2.79 ppm; 3.1-3.5 ppm; 3.63 ppm; 3.99 ppm; |
| (diol = tetraethylene glycol) | 4.26 ppm; 4.43 ppm (DMSO d-6) |
| Polymers of Example 2 | 2.1 ppm; 2.3 ppm; 3.6-3.9 ppm; 4.0 ppm; 4.2 ppm (D₂O) |
| (diol = triethylene glycol) | |
| Polymers of Example 3 | 3.6-3.9 ppm; 4.0 ppm, 4.2 ppm (D₂O) |
| (diol = diethylene glycol) | |
| Polymers of Example 5 | 1.7-2.0 ppm; 3.0-3.2 ppm; 3.6-3.8 ppm; 4.1 ppm (D₂O) |
| (diol = 1,3-propanediol) | |
| From Example 6 | 3.6-3.9 ppm; 4.2 ppm (D₂O) |
| (diol = PEG 400) | |
| From Example 7 | 2.43 ppm; 3.13 ppm; 3.3-3.5 ppm; 3.73 ppm; 4.05 ppm; 4.53 ppm |
| (diol = 2,2,3,3-tetrafluoro-1,4- | (DMSO d-6) |
| butanediol + tetraethylene glycol) | |
| From Example 11 | 1.2-1.8 ppm; 2.0 ppm; 2.5 ppm; 2.8 ppm; 2.9 ppm; 3.2-3.8 ppm; |
| (diol = 1,6-hexanediol) | 4.4 ppm; 7.2 ppm (DMSO d-6) |

Collectively, the FTIR and NMR spectrum of the polymer of the invention shown that in lithiated repeat units, the nitrogen atoms have lost one of their hydrogen atoms and are coordinated with a lithium atom, thus forming a complex with this lithium ion.

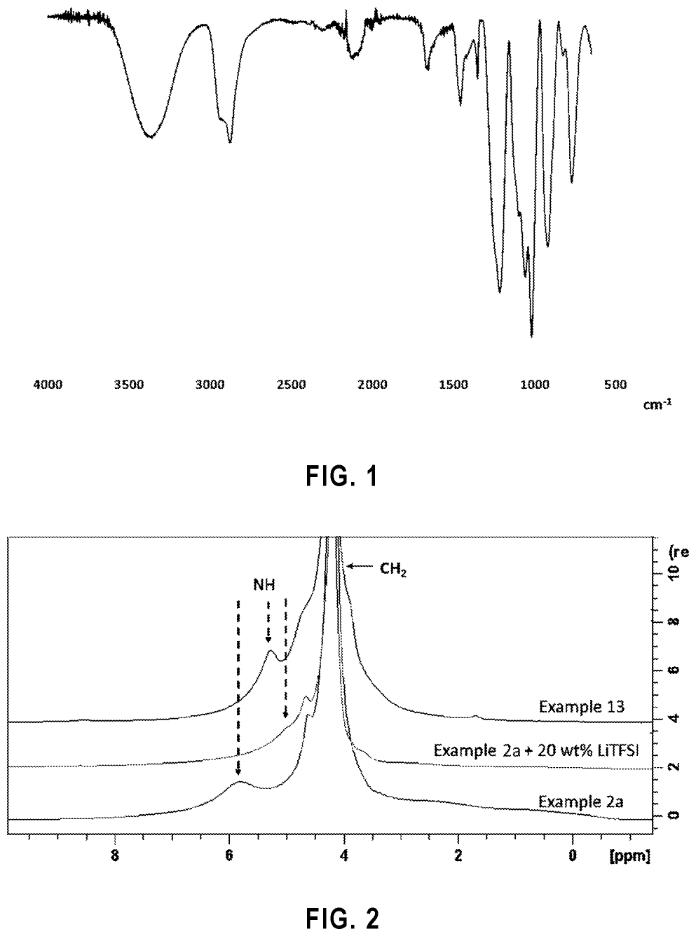

FIG. 1 shows the FTIR spectrum of the polymer of Example 13 (i.e. the polymer of Example 2a after treatment with the ion-exchange resin). The band attributed to the imine (C═N) (Schiff base) vibration and located at 1628 cm⁻¹ is shifted at 1653 cm⁻¹ (shift of 25 cm⁻¹) and the band located at 1712 cm⁻¹ is absent from the spectrum after treatment. This is indicative that the nitrogen atoms form a complex with the lithium ion.

| Polymer | List of FTIR peaks (cm⁻¹) |
|---|---|
| From Example 2a | 3382; 2931; 2875; 1712; 1628; 1456; 1351; |
| | 1215; 1082; 1057; 1018; 916; 801; 769 |
| From Example 13 | 3345; 2931; 2872; 2293; 1653; 1456; 1350; |
| | 1211; 1086; 1055; 1017; 916; 820; 769 |

Polymers were also characterized by inversion recovery measurement of longitudinal NMR relaxation time (T1) for 1H, 7Li and 19F nuclei. NMR experiments were carried out using 600 MHz Bruker Avance III NMR spectrometer equipped with double resonance 5 mm broadband probe. T₁ measurements were done at the temperature range of 326-371 K for the polymer of Example 2a and 330-378 K for the polymer containing LiTFSI. The recovery time delay varied in 16 steps from 100 μs to 5 s.

Characterization of local dynamics within the polymer structure using NMR T₁ relaxation technique revealed that Li is mostly located near nitrogen in the polymers.

FIG. 2 shows the ¹H solid NRM spectrum of the polymers of Example 2a, Example 13 and Example 2a with 20 wt % LITFSI. The NH peak is shifted to the right for the polymer of Example 13 (5.3 ppm) compared with the polymers of Example 2a where this peak was at 5.8 ppm. The position of this peak therefore depends on degree of lithiation. In the spectrum of the polymer of Example 2a with 20 wt % LITFSI, this peak probably is probably overlapping at 5.0 ppm with CH₂ signals.

### Further Characterization

The method has been shown to produce linear polymers with of various molar masses. These have no crystallinity with a glass transition temperature (Tg) around −30° C. or lower.

The molar mass of the produced polymers was determined using gas-phase chromatography (GPC) in DMF at 60° C. with universal calibration based on Poly(styrene) standards. The molar mass of the produced polymers (Examples 3e and 3f) was determined using GPC in water at 40° C. with triple detection. The Tg was determined by DSC, 2 cycles at 10° C./min. The results are summarized in the table below.

| Polymer | Molar Mass (Mn) (g/mol) | Tg (° C.) |
|---|---|---|
| Example 1a | Not available | −31 |
| Example 1b | Not available | −55 |
| Example 2a | Not available | — |
| Example 3a | Not available | −42 |
| Example 3e | 33 200; 7 700 | Not available |
| Example 3f | 120 000 | Not available |
| Example 7 | 8 000; 7 600; 3 500 | Not available |
| Example 8 | Not available | −57 |
| Example 11 | 5 100; 5 800 | −68 |

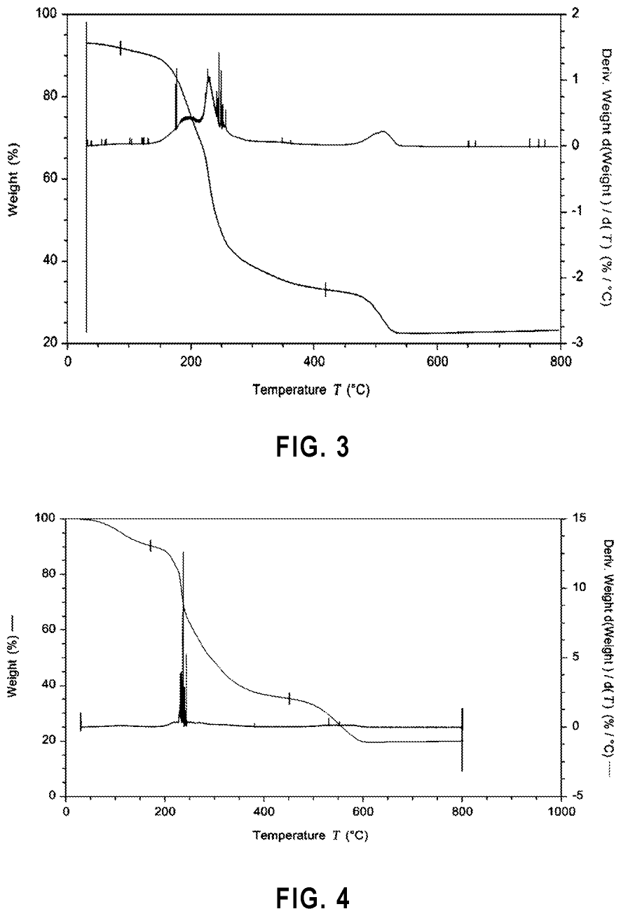

FIGS. 3 and 4 show the thermogravimetric analysis (TGA) results for the polymer of Examples 1b and 3a, respectively. The polymers are a profile typically of polymer and show a relatively good stability to heat.

### Conductivity of the Polymers

The conductivity of the polymer was measured as described below.

### Preparation of Solutions

In an anhydrous chamber, one gram of the polymer 2a was inserted in each of 6 separate vials. Then, to each vial was added either 0, 10, 20, 30, 40, or 50 w/w % of lithium bis(trifluoromethanesulfonyl)imide (LiTFSI). These percentages are based on the total weight of the polymer/LiTFSI mixture (20 w/w % LiTFSI=1 g of polymer+0.25 g of LiTFSI). The samples were vortexed. Then, a solvent (anhydrous MeOH) was added and the samples were mixed until they exhibited a honey-like viscosity. The samples were homogenized using a roller mixer overnight or until homogeneous solutions were obtained

### Coating

The materials used were:
Zehntner® ZAA 2300 coating table,
Square film applicator (Dr Blade®) (5 cm),
Anhydrous ethanol,
Pre-washed stainless-steel collector, and
Polypropylene tape.

The coating table and the applicator were washed with ethanol. The stainless-steel collector was placed on the coating table (under the support bar) and a small amount of ethanol was added under the collector then smoothed with a Kimwipe® to ensure good adhesion to the coating table as well as a smooth surface. Polypropylene strips of the width of the 5 cm applicator of was added (under the support bar). The applicator was placed on the polypropylene strips. The selected thickness for polysulfonamide was 5 mils+1 mils (polypropylene tape). The 20 polymer mixture was added with a spatula in the applicator and coating was started (coating speed 8 RPM). The applicator, excess mixture and the polypropylene strips was removed. The film was placed on a steel plate, which was then placed in a vacuum oven preheated to 80° C. The film remained in the vacuum oven overnight.

### Button Cell Battery Assembly

Since the polymer were very sticky, assembly is challenging and to facilitate the task, the films were prepared in an anhydrous chamber. The batteries were assembled in a laboratory glovebox.

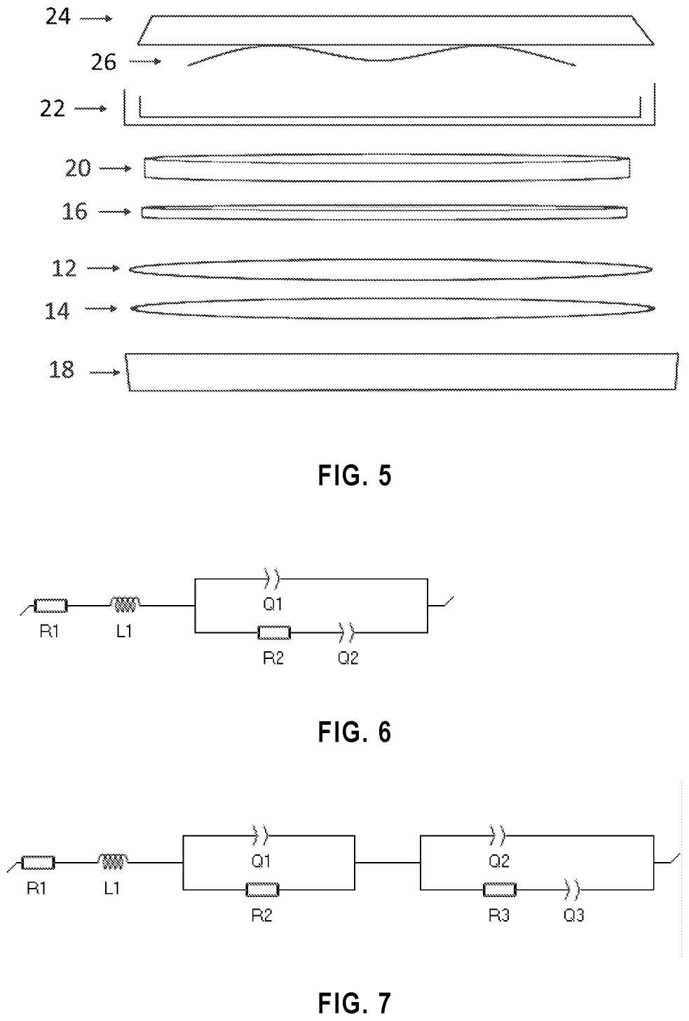

FIG. 5 is an exploded view of the button cell battery (10) used for these tests. First, the polymer film (12) and the stainless-steel collector (14), as prepared in the previous step, were cut to size (18 mm in diameter). Then a 0.5 mm thick spacer (16) of the same diameter was placed on top to the polymer film (12). If the spacer (16) did not stick to the surface of the polymer film (12), the polymer film (12) was heated at 50° C. for about 1 minute, then the spacer (16) was reapplied.

The thickness of the polymer film (12) was calculated from the measured total thickness of the stainless-steel collector (14), polymer film (12), and spacer (16) assembly, subtracting the thicknesses of the stainless-steel collector (14) and spacer (16), 28 μm and 500 μm, respectively.

Finally, the stainless-steel collector (14), polymer film (12), and spacer (16) assembly was placed in a button cell battery box (18). A second 0.5 thick mm spacer (20) and then a plastic gasket (22) were placed on top of the assembly. The button cell was place under vacuum for 1 h. Finally, the button cell batteries were closed with a button cell cover (24), fitted with a welded sprint (26), then sealed with a crimper.

### Conductivity Analysis Procedure & Data Analysis

The batteries were placed in an Espec® oven. A BioLogic VMP3 cycler was used to measure the conductivity between 10° C. and 90° C. in 10° C. increments, twice.

At each temperature, two impedance measurements were made to ensure the thermal stability of the sample. A total of 36 impedance values were measured. If the two impedances were identical, then only the first impedance value was used for analysis.

The ZFit option from EC-Lab was used to determine the value of the resistance connected to the electrolyte. If the semicircle on the impedance was perfectly symmetrical, the equivalent circuit shown in FIG. 6 was used and the R2 value was used for the conductivity calculation. On the other hand, if the semi-circle was not symmetrical or if there were two semi-circles, the equivalent circuit shown in FIG. 7 was used. Again, the R2 value was used for the conductivity calculation.

To calculate the conductivity, we used the following equation:

$$Conductivity = \frac{T \times 0.0001}{A \times R}$$

wherein:
T is the calculated thickness of the polymer film (12) in μm,
A is the contact area between the polymer film (12) and spacer (16) in cm²—here this value was 2.01 cm²,
R is the resistance measured using the equivalent circuit (see FIGS. 6 and 7), and
the calculated conductivity is in S/cm.

### Conductivity Results

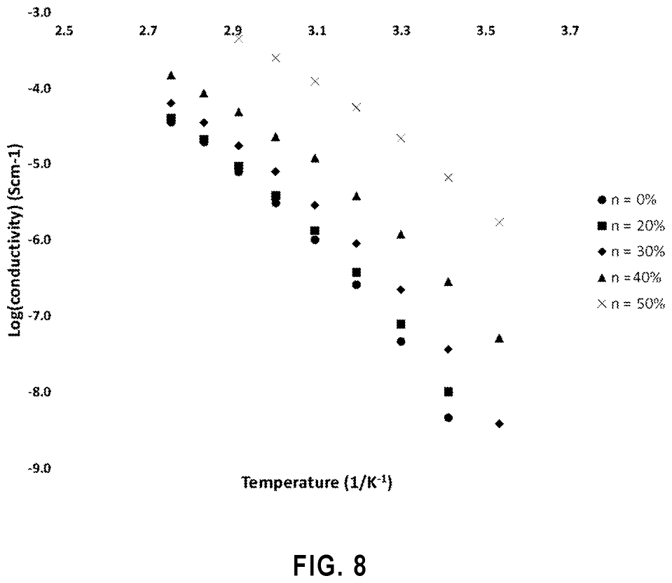

FIG. 8 shows the conductivity results for the polymer of Example 2a (made from triethylene glycol) with either 0, 20, 30, 40, or 50 w/w % of LiTFSI.

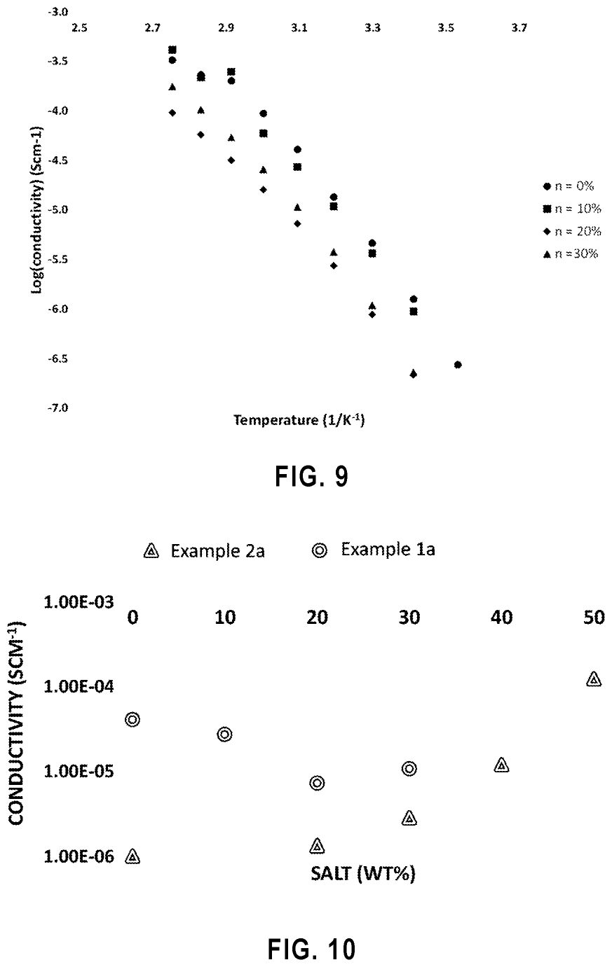

FIG. 9 shows the conductivity results for the polymer of Example 1a (made from tetraethylene glycol) with either 0, 10, 20, or 30 w/w % of LiTFSI.

FIG. 10 compares the conductivities at 50° C. for the polymer of Example 2a (made from triethylene glycol) and the polymer of Example 1a (made from tetraethylene glycol) at different salt levels.

It can be seen from the above that the polymer made from tetraethylene glycol exhibited higher conductivities than the polymer made from triethylene glycol. Also, this polymer made from tetraethylene glycol exhibited highest conductivities without salt: the conductivity was 4.10×10⁻⁵ Scm⁻¹ at 50° C.

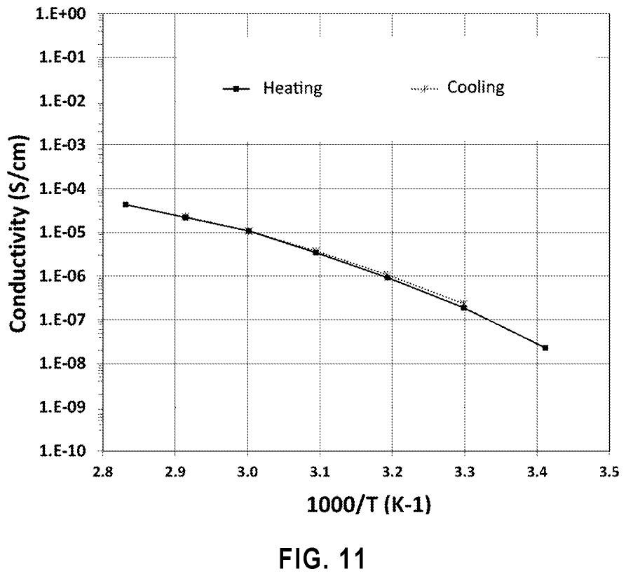

FIG. 11 shows the conductivity of the polymer of Example 1b mixed with 15 wt % of polymer HQ674 (one curve recorded during heating, the other recorded during cooling). Polymer HQ674 is a polymer as described in U.S. Pat. No. 7,897,674, used to increase the mechanical properties of the resulting mixture.

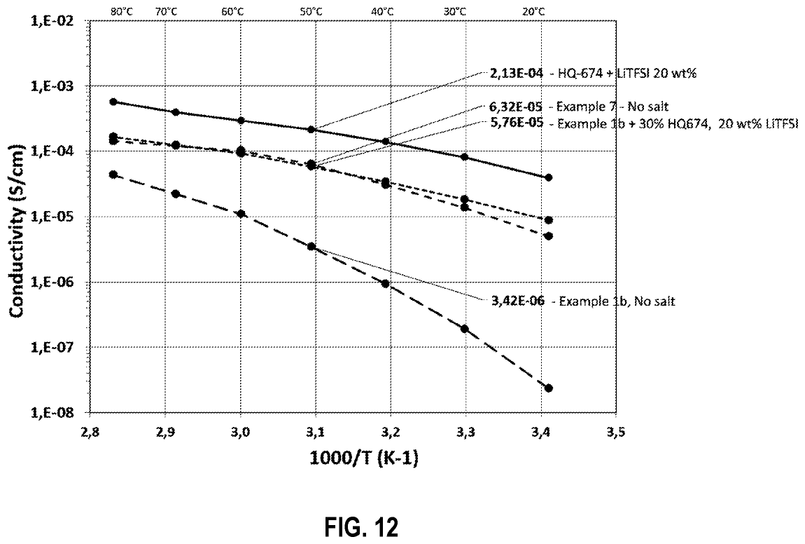

FIG. 12 shows the conductivity at 50° C. of the polymers of Examples 1b and 7, with or without salt, without or without polymer HQ674 and compares the conductivity of polymer HQ674. The results are also summarized below:

| | Conductivity @ | |
|---|---|---|
| Samples | 50° C. | Thinkness |
| HQ-674 + LiTFSI | 2.13E−04 | 50 μm |
| 20 wt % | 1.65E−04 | 20 μm |
| Example 7 - No salt | 0.632E−04 | 30 μm |
| Example 1 b + 30% HQ674, | 0.576E−04 | 60 μm |
| 20 wt % LiTFSI | | |
| Example 1b, No salt | 0.0342E−04 | 50 μm |

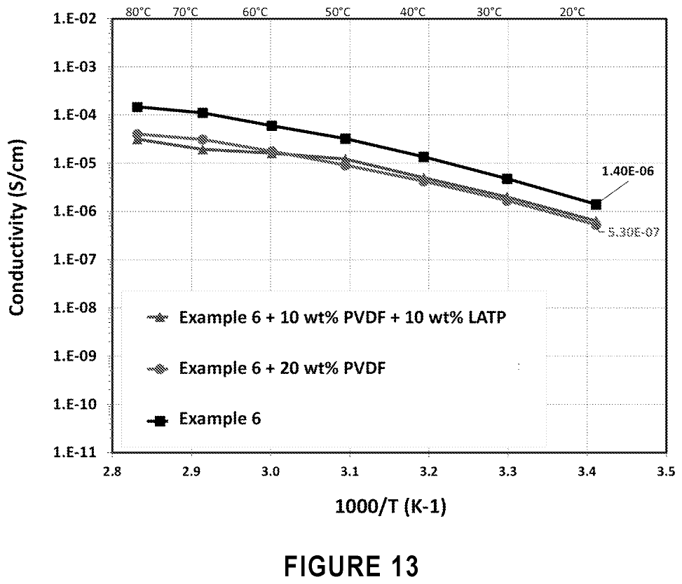

FIG. 13 shows the conductivity results for the polymer of Example 6 (made from PEG 400) alone, mixed with polyvinylidene fluoride (PVDF), or mixed with PVDF and lithium aluminum titanium phosphate (LATP).

The activation energy can be extrapolated from the slope of the conductivity curve. The activation energy for the polymers of the invention is presented in the following table:

| | Activation Energy | Activation Energy | Activation Energy |
|---|---|---|---|
| | without | 20 w/w % | 50 w/w % |
| Polymer | salt (eV) | salt (eV) | salt (eV) |
| Example 1a | 0.35 | 0.30 | Not available |
| Example 2a | 0.50 | 0.46 | 0.34 |

We can see that the activation energy is very different from that typically observed for polymers (1.7 eV PEO crystal+Li). It is much better and is, in fact, closer to that reported for ceramics (0.30 eV). Activation energies are an indication of the mechanism/mode of conduction of the polymer. We therefore conclude that this mechanism is different in the polymer of the invention compared to the usual polymers.

Furthermore, solid NMR showed that the transport number of Li was 0.88.

| | Transport Number | Transport Number |
|---|---|---|
| Polymer | without salt | 20 w/w % salt |
| Example 1a | 0.88 | 0.47 |

Namely, to determine the transport number, the longitudinal (T₁) and the transverse (T₂) NMR relaxation times of ¹H, ⁷Li, and ¹⁹F nuclei were measured in the temperature range from 323 till 378 K using a Bruker 600 MHz Avance III NMR spectrometer equipped with double resonance 5 mm broadband probe. Resonance frequencies of ¹H, ⁷Li, and ¹⁹F are 599.9, 233.1 and 564.4 MHz, respectively. T₁ data were collected using inversion recovery experiment with the recovery delay varied in 16 steps from 100 μs to 5 s and the relaxation delay between scans of 1 s. A standard Carr-Purcell-Meiboom-Gill (CPMG) pulse sequence was used to measure T₂; up to 480 echoes were collected with the echo delay of 200 μs.

¹H, ⁷Li, and ¹⁹F diffusion coefficient were measured at 323 K using a Bruker 300WB NMR spectrometer operating at 300.3 MHz for ¹H, 116.7 MHz for ⁷Li and 282.3 MHz for ¹⁹F, with a Diff50 gradient probe (maximum gradient strength of 2750 G/cm). Diffusion data were collected using the bipolar gradient longitudinal eddy current delay (BPLED) pulse sequence. The strength of the field gradient (g) was increased in 16 equidistant steps up to a 95% of the maximum allowed value, while the length of the gradient pulse (δ) and diffusion time (Δ) were adjusted to the observing nucleus depending on the expected diffusion coefficient. In general, δ and Δ were in the range of 1-2 ms and 100-200 ms, respectively.

As it can be seen from the above, the performances of the polymers deteriorate in the presence of a lithium salt, such as LiTFSi. A better conductivity and a better transport number are observed without salt. This is further evidence that we have another mode of conduction for the polymers of the invention.

### CCD Scans

In order to investigate the electrochemical performance and to understand the failure mechanism of the polymer, a Li/Li symmetric cell was prepared with the polymer as separator. The areal capacity was set to 1.28 mAh/cm² and the current density for 1/nC (n=1, 1 h of charge and 1 h of discharge) was 1.28 mA/cm². An incremental current density of 0.054 (C/24), 0.107 (C/12), 0.214 (C/6), 0.427 (C/3), 0.640 (C/2), 1.28 (1C), 2.56 (2C), 3.84 (3C), 5.12 (4C) and 6.4 (5C) mA/cm² were applied. The critical current density of the polymer was identified when the overpotential of the cell went above 1V.

The polymer of Example 1a (15%)+HQ674 (85%), without LiTFSI, showed a critical current density of 2.56 mA/cm² (defined as 2C) whereas the HQ-674 polymer only reached a current density of 0.214 mA/cm² before failure.

The overpotential of the polymer of Example 1a (15%)+HQ674 (85%), without LiTFSI, at 1.28 mA/cm² (1C rate) was 0.07 V, while this value was obtained at a low current density of 0.214 mA/cm² (C/6 rate) for the HQ-674 polymer.

### References

The present description refers to a number of documents, the content of which is herein incorporated by reference in their entirety. These documents include, but are not limited to, the following:
Christophe Michot, Contribution à l'étude du transport des ions et des électrons en milieu polymère solvatant: applications aux générateurs et aux systémes électrochromes, doctoral thesis, Université de Grenoble, http://www.theses.fr/1995INPG0061
Shi et al., Copper-Catalyzed Alkylation of Sulfonamides with Alcohol, Angew. Chem. Int. Ed., 2009, 48, 5912-5915.
De Zea Burmudez et al., Chemistry and physical properties of sulfamide and its derivatives: proton conducting, Materials, J. Mater. Chem., 1997, 7 (9), 1677-1692.
De Zea Burmudez and Sanchez, Sulfamide complexes of polymethacrylates carrying oligopolyoxyethylene chains, Solid State Ionics, 61 (1993) 203-212.
Choquette et al., Sulfamides and Glymes as Aprotic Solvents for Lithium Batteries, 1998, J. Electrochem. Soc., 145, 3500.
U.S. Pat. No. 7,897,674.
U.S. Pat. No. 6,190,804.

1. A polymer of formula (I): 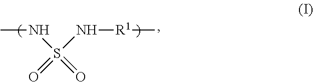
wherein:
the nitrogen atoms are coordinated with a lithium atom in 0% to 100% of repeat units in the polymer, and
each R¹ in each individual repeat unit independently represents a bivalent group, wherein the bivalent groups are, independently from one another, alkylene, arylene, or —CH₂—CH₂—(O—CH₂—CH₂)ₘ—, wherein:
m is an integer of 1 or more, and
the alkylene, the arylene, and the —CH₂—CH₂—(O—CH₂—CH₂)ₘ— are optionally substituted with one or more halogen atoms.

2. The polymer of claim 1, wherein the nitrogen atoms are coordinated with a lithium atom in >0%, preferably at least about 50%, more preferably at least about 60%, yet more preferably at least about 70%, even more preferably at least about 80%, still more preferably at least about 90%, and most preferably in about 100% of the repeat units in the polymer.

3. The polymer of claim 1 or 2, wherein the alkylene is a linear alkylene.

4. The polymer of any one of claims 1 to 3, wherein the alkylene is a C₃-C₁₂alkylene, preferably a C₃-C₆alkylene, and most preferably butylene (C₄).

5. The polymer of any one of claims 1 to 4, wherein each of the rings of the arylene comprises 5 or 6 ring atoms.

6. The polymer of any one of claims 1 to 5, wherein the arylene is a monocyclic arylene, preferably phenylene, more preferably paraphenylene.

7. The polymer of any one of claims 1 to 6, wherein the alkylene is substituted with one or more halogen atoms.

8. The polymer of any one of claims 1 to 7, wherein the halogen atoms are fluorine atoms.

9. The polymer of any one of claims 1 to 8, wherein the alkylene is 2,2,3,3-tetrafluoro-1,4-butylene.

10. The polymer of any one of claims 1 to 6, wherein the alkylene is unsubstituted.

11. The polymer of any one of claims 1 to 10, wherein the arylene is unsubstituted.

12. The polymer of any one of claims 1 to 11, wherein m is at least 2, preferably at least 3.

13. The polymer of any one of claims 1 to 12, wherein m is at most 15, preferably at most 10, and more preferably at most 5.

14. The polymer of any one of claims 1 to 13, wherein m is 1, 2, or 3; preferably 2 or 3, and more preferably 3.

15. The polymer of any one of claims 1 to 14, wherein each R¹ in each individual repeat unit represents a same bivalent group.

16. The polymer of claim 15, wherein R¹ represents an alkylene or —CH₂—CH₂—(O—CH₂—CH₂)ₘ—; more preferably —CH₂—CH₂—(O—CH₂—CH₂)ₘ—, wherein the alkylene and m are as defined in any one of claims 1 to 14.

17. The polymer of any one of claims 1 to 13, wherein each R¹ in each individual repeat unit independently represents a total of more than one bivalent group, preferably a total of two bivalent groups.

18. The polymer of claim 17, wherein the more than one bivalent groups are independently alkylene and/or —CH₂—CH₂—(O—CH₂—CH₂)ₘ—.

19. The polymer of claim 17 or 18, wherein each R¹ in each individual repeat unit independently represents a total of two bivalent groups, wherein:
one of the two bivalent group is an alkylene and the other of the two bivalent groups is —CH₂—CH₂—(O—CH₂—CH₂)ₘ—, or
one of the two bivalent group is —CH₂—CH₂—(O—CH₂—CH₂)ₘ—, wherein m has a first value, and the other of the two bivalent groups is —CH₂—CH₂—(O—CH₂—CH₂)ₘ—, wherein m has a second value different from the first value,
wherein the alkylene and m are as defined in any one of claims 1 to 13.

20. The polymer of claim 19, wherein the first value and the second value for m are selected from 1, 2, and 3; preferably from 2 and 3.

21. The polymer of any one of claims 1 to 20, wherein:
each R¹ in each individual repeat unit represents —CH₂—CH₂—(O—CH₂—CH₂)ₘ—, wherein m is 2 or 3, preferably 3;
each R¹ in each individual unit independently represents a total of two bivalent groups, wherein one of the two bivalent groups is —CH₂—CH₂—(O—CH₂—CH₂)ₘ—, wherein m is 2, and the other of the two bivalent groups is —CH₂—CH₂—(O—CH₂—CH₂)ₘ—, wherein m is 3;
each R¹ in each individual repeat unit independently represents a total of two bivalent groups, wherein one of the two bivalent groups is 2,2,3,3-tetrafluoro-1,4-butylene and the other of the two bivalent groups is —CH₂—CH₂—(O—CH₂—CH₂)ₘ—, wherein m is 2 or 3, preferably 3.

22. The polymer of any one of claims 1 to 21, wherein the repeat units are randomly arranged in the polymer.

23. The polymer of any one of claims 1 to 22, having a molar mass between 5,000-5,000,000 gmol⁻¹.

24. The polymer of any one of claims 1 to 23, having no crystallinity

25. The polymer of any one of claims 1 to 24, having a glass transition temperature (Tg) around −30° C.

26. A method of manufacturing the polymer of any one of claims 1 to 25, the method comprising an oxidative catalytic reaction of sulfamide with one or more diols in the presence of a copper salt and optionally a lithium base.

27. The method of claim 26, wherein the one or more diol is used in excess

28. The method of claim 27, wherein the sulfamide and the one or more diol are used in a 1:4 sulfamide:total diol molar ratio.

29. The method of any one of claims 26 to 28, wherein a single diol is used.

30. The method of any one of claims 26 to 28, wherein more than one diols are used.

31. The method of any one of claims 26 to 30, wherein the copper salt is copper triflate or copper acetate.

32. The method of any one of claims 26 to 31, wherein the lithium base is present.

33. The method of any one of claims 26 to 32, wherein the lithium base is lithium carbonate.

34. The method of any one of claims 26 to 33, wherein the copper salt is copper acetate.

35. The method of any one of claims 26 to 34, further comprising the step of passing the polymers in an ion-exchange resin on the polymer post-polymerization to increase a degree of lithiation of the polymer.

36. The method of any one of claims 26 to 31, wherein the lithium base is absent.

37. The method of any one of claims 26 to 31 and 36, wherein the copper salt is copper triflate.

38. The method of any one of claims 26 to 37, wherein the sulfamide, the copper salt, and the lithium base if it is used, are first mixed together and then diol is added.

39. Use of the polymers of any one of claims 1 to 25 as an electrolyte for a battery.

40. An electrolyte for a battery comprising the polymer of any one of claims 1 to 25.

41. A battery comprising an anode, a cathode, and an electrolyte between the anode and the cathode, wherein the electrolyte comprises the polymer of any one of claims 1 to 25.
